(19) United States
(12) Patent Application Publication
(10) Pub. No.: US 2025/0065218 A1
(43) Pub. Date: Feb. 27, 2025

(54) Word game with player-driven letter rearrangement

(71) Applicant: Evelyn Mary Stiller, Freedom, NH (US)

(72) Inventor: Evelyn Mary Stiller, Freedom, NH (US)

(21) Appl. No.: 18/237,538

(22) Filed: Aug. 24, 2023

(51) Int. Cl. A63F 3/04; A63F 13/822

(52) U.S. Cl. CPC A63F 3/0423; A63F 13/822; A63F 2003/0426

(57) ABSTRACT

This invention is a word puzzle (game) that uses a square grid of letters. The grid is comprised of a plurality of rows and columns of letters, where the number of rows and columns is equal. The preferred embodiment has four rows and four columns, but other dimensions are possible. This puzzle is geared primarily for individual players using internet-based embodiments, but this puzzle could also be the basis for a multi-player board game or have other physical embodiments. The player is presented with a square grid of letters, and the player's goal is to rearrange the letters to spell a plurality of words of a specified length. The number of words required for a correct solution and the number of letters in each word comprising the solution equal the dimensions of the grid. For example, the four-by-four grid solution requires four four-letter words for a correct solution.

### BACKGROUND OF THE INVENTION

### Field of the Invention

The various embodiments of the proposed invention are a form of word game. Specifically, it is a two-dimensional puzzle consisting of lettered tiles or other lettered objects.

### Description of Related Art

Many word games already exist, so to draw a distinction between the proposed word game and those already in existence, the basic characteristics of this game will be enumerated and then compared to previous inventions. The proposed word game entails player-driven word formation, as opposed to word recognition. The letters selected for play are determined by a computer algorithm or are manually determined, as opposed to being randomly selected or being selected in a player-driven manner, with the notable exception in which players create the word puzzle. The proposed games take place on a square, grid configuration of letters, which consists of a plurality of rows and columns containing an equal number of letters. The dimensions of the letter grid determine the word length for words making up the solution of the puzzle. The solution to the game/puzzle consists of a predefined minimum number of words containing a fixed number of letters matching the dimensions of the game grid. For example, if the game is played on a four-by-four grid the solution consists of four, four-lettered words. The essential player activity entails changing positions of predetermined letters within the grid to form the goal word configuration. The words comprising a solution can fill a row or column of the grid, thus words can share letters. Many word-jumble or scramble games ask players to rearrange letters to spell individual words or a series of individual words, as opposed to creating a two-dimensional configuration of words that comprise a game solution from the proposed invention. Finally, a dictionary is used to identify qualifying words because players may find a solution other than the preselected solution used to determine the puzzle.

The proposed invention is based on player-driven word formation, as opposed to player-driven word recognition, or finding. One game that structurally resembles a four-by-four embodiment of the proposed invention rather closely is Boggle. Boggle differs from the proposed invention in two important regards. First, Boggle uses the randomization of lettered cubes to determine letter placement. The lettered cubes are shaken to randomly distribute them in a four-by-four configuration. The second respect in which Boggle differs from the proposed invention is that Boggle centers around player identification or recognition of words, as opposed to the formation of words by reconfiguring the letter arrangement. U.S. Pat. No. 8,408,548 B2, awarded Apr. 2, 2013 to Kellond relates to Boggle. Many other patents exist for word games that are predicated on word recognition rather than word formation including, U.S. Pat. No. 4,601,473 awarded July 1986 to Drubren. Another game that relies on word recognition versus word construction is U.S. Pat. No. 10,065,104, awarded Sep. 4, 2018, to Dumitrescu, which also uses a dictionary to select words used to populate the puzzle with at least one word and is thus similar to the proposed invention in this regard. The U.S. Pat. No. 3,871,1307 awarded Nov. 22, 2007, to Graybill is a form of word finding game in which letters of a word can span multiple rows and columns, as long as the connected letters share a row or column. The Graybill invention takes the form of a word-search, word-link, word-scramble trivia game, distinguishing it from the word-formation game described in this application.

The proposed invention uses an algorithm-driven letter selection process that targets a randomly selected puzzle solution to determine the letters making up the grid, with the exception of the player-driven game-making option where the game-maker is not the puzzle-solver. The letter selection technique distinguishes the proposed invention from many word games. U.S. Pat. No. 4,019,743 awarded Apr. 26, 1977, to Castanis, uses player-driven letter placement in a 4×4×4, three-dimensional configuration. The players select letters from a repository of randomly distributed letters and then place them on the 3-D configuration to form words. Other word formation games that rely on player-driven letter selection include Scrabble and other Scrabble-like games, such as the invention identified in U.S. Pat. No. 10,124,243 B1 awarded to Baugh on Nov. 13, 2018. This invention uses a combination of randomized letter location and player-driven letter selection. Another game using player-driven letter placement is identified in U.S. Pat. No. 9,744,439B2 awarded Aug. 29, 2017 to Russocki for the game, Jabuka.

Word Swap is a game that utilizes player-driven letter rearrangement as a means of word formation. Players rearrange individual rows of letters to reveal scrambled words. Word swap differs from the proposed invention by having players descramble a single word at a time. The proposed invention scrambles all letters on the grid without regard to individual words. Also, the proposed invention does not have a single correct solution, unlike Word Swap by iGold technologies. Also, the focus of this game is the number of letter-swaps necessary to form the word.

Other games that use player-driven letter rearrangement to form words include word jumbles and word scrambles. A word jumble which can be found at https://games.usatoday.com/games/amu-jumble https://www.jumble.com/jumble2d facilitates the creation of single words at a time using clues to prompt players to find the correct word. A word scramble such as Word Scramble, which can be found at https://games.usatoday.com/games/word-scramble, also asks players to solve one word at a time. The proposed invention requires all words to coexist in a two-dimensional grid configuration to solve a puzzle, unlike these games that precede a single word at a time.

Finally, it is important to note that the inventor has disclosed a version of the invention on the website, http://playfourword.org/. The game is called Four Word and can be played on any device that runs a web browser. This game embodies a four-by-four version of the game grid of letters and requires four four-lettered words to exist on the grid simultaneously to correctly solve the puzzle. This game should not be confused with another game called, Four Word, which is a game by Yoozoo corporation and can be found at the Google store. This game involves single word at a time word descrambling like the word jumbles/scrambles described in the previous paragraph.

### SUMMARY OF THE INVENTION

The first aspect of this invention is a letter grid that consists of a plurality of rows and columns of lettered tiles that form a square configuration. In other words, the number of rows equals the number of columns. The preferred embodiment of this invention uses a four-by-four letter grid. Words may be formed horizontally, reading left to right, and vertically, reading from top to bottom, but not diagonally.

The second aspect of this invention is a method of computer generation (algorithm) of a configuration of letters to fill the grid, with one letter on each tile comprising the grid. These letters will be arranged and displayed as lettered tiles for players to rearrange to solve the puzzle. The computer algorithm selects random words from a wordlist of suitable words to ensure a solution exists for each game generated. The second aspect of this invention can have a variety of computer-based methods for selecting words to generate the letters for each game. The method for computer-based letter selection that follows describes one such approach. This word selection algorithm is the puzzle creation algorithm.

For the preferred four-by-four, computer-based grid embodiment, the word selection (puzzle creation) algorithm starts by selecting an initial word at random from a wordlist containing four-lettered words. This word is then positioned on the letter grid in a random horizontal or vertical location, where the horizontal word is read from left to right and the vertical word is read from top to bottom. A second word is then selected in such a manner that it intersects with the first word. In other words, if the first word is positioned horizontally the second word is positioned vertically, sharing one intersecting letter. A letter from the first word is selected at random to form the second intersecting word. A subset of the wordlist is created consisting of words that contain the intersecting letter in the position necessary for the second word to intersect the first word and be fully on the four-by-four grid. The second word is then randomly selected from this subset of words. The third and fourth words are then selected to also intersect the first word in a similar manner. In some instances, four words cannot be selected, so the process starts from the beginning with a new first word until at least four words are placed on the letter grid, reading horizontally and vertically. The configuration of letters containing at least four four-lettered words represents a solution to the puzzle. This letter configuration on the grid is randomly rearranged before being presented to the player so that the player may attempt to solve the puzzle. Any configuration of letters that contain four four-lettered words on the grid is considered a correct solution to the puzzle, whether it matches the predetermined solution or not.

Most embodiments of this invention will use some sort of computer-generated word/letter selection method as the basis for creating puzzles. However, there is potential for a player-driven word/letter selection approach in which one player challenges another player to solve a puzzle developed by the first player.

The third aspect is the player-driven letter rearrangement process. The letter rearrangement process is how players engage in gameplay. This aspect addresses how players move letters within the grid to solve the puzzle. In the preferred, Internet-based embodiment of this invention players swap lettered tiles by clicking on one tile and then clicking on a second tile. The letters on the selected tile pairs switch location after the second tile is selected. Players engage in a series of tile swaps to rearrange the letters and thereby solve the puzzle.

The fourth aspect involves using wordlists to create generic, specialized, or non-English language versions of the word game. The preferred embodiment of this invention uses four-lettered words from a standard dictionary as the basis of the wordlist. These wordlists are used to pick the random words used to create the puzzle in the puzzle creation algorithm, as described in the second aspect of the game.

The fifth aspect of this invention requires a computer-based embodiment. The fifth aspect provides a mechanism for the players to check their progress toward solving the puzzle. A check function evaluates the player's solution and checks for possible words. In the case of the preferred four-by-four embodiment, the computer algorithm checks the four vertical words, reading from top to bottom, and the four horizontal words, reading from left to right, against the wordlist discussed in the fourth aspect of the invention. All words found in the wordlist are reported back to the player using the computer interface. If four or more words are found the player wins the game.

The sixth aspect of this invention also requires a computer-based embodiment. The sixth aspect provides a means for players to view a solution to the puzzle. This mechanism is called the “I Give up” function in the preferred embodiment of the invention. Players may wish to end gameplay and see the solution to the puzzle they are working on. A link is provided so that players can view the computer-generated solution to the puzzle. Such a feature is particularly useful to new players who are learning to play the game.

The seventh aspect of the invention also requires a computer-based embodiment. The seventh aspect is the “puzzle of the day” or POD. Each day a new puzzle is created, with possible manual intervention, for all players to share. In other words, when players select the POD option, they are playing the same puzzle as any other player selecting POD. In the preferred embodiment, the POD is generated from a file that determines the POD, and a new POD puzzle is selected from the file at midnight eastern standard time. Players have until midnight to solve the puzzle and each player is notified how much time elapsed between initiating the POD and solving the POD. This allows for competition between players.

### BRIEF DESCRIPTION OF THE DRAWINGS

FIG. 1 shows a sample two-dimensional grid of letters used in the preferred embodiment of the invention. The letter grid consists of four rows and four columns of tiles, each containing one lowercase letter. The numbers 1 through 16 identify each lettered tile comprising the grid.

FIG. 2 shows the four columns that can be used to create four of the possible eight words that players could create using lettered tiles on the grid. The values 30 through 33 identify each column respectively. In this depiction, the tiles do not contain letters, but column designations. For example, C1 indicates column one, C2 indicates column two, and so on. In normal gameplay, tiles always contain letters, rather than column designations.

FIG. 3 shows the four rows that can be used to create four of the possible eight words that players could create using lettered tiles on the grid. The values 50 through 53 identify each row respectively. In this depiction, the tiles do not contain letters, but row designation instead. For example, R1 indicates row one, R2 indicates row two, and so on. In normal gameplay, tiles always contain letters.

FIG. 4 shows an alternative to the preferred embodiment of the invention. This alternative embodiment uses a physical device, rather than a computer-based representation of the lettered grid. The physical embodiment is like that of a 15-puzzle, in which the player rearranges numbered tiles to create a numeric sequence. This embodiment requires one empty space in the grid. The number 60 identifies the empty space. This allows players to slide selected neighboring tiles into the empty space and thus facilitate the rearrangement of tiles. Numbers 61 through 64 identify the four neighboring tiles in this scenario that could be moved into the empty space.

FIG. 5 shows a hypothetical puzzle creation process/algorithm that is used by the preferred embodiment of the invention. Each number, 70 through 76 illustrates one step in the puzzle creation process. The number, 70 shows a randomly selected word from the wordlist, “word” in this case. The number, 71 shows the selection of a second word slated to intersect the first word. The second word is “fore” in this hypothetical example. The number, 72 shows the selection of the third word in this hypothetical example. The third word is “afro” and is slated to intersect the second word. The number, 73 shows the fourth and final word being selected. The final word is “awry”. Several tiles remain without assigned letters after the random word selection process is complete. The empty tiles are identified by the number, 74. Random letters are normally assigned to these tiles, but the letters a,b,c, and d are used in this hypothetical example, as shown by 75. The number, 76 shows a randomly rearranged sequence of lettered tiles that shows what a player would get in this hypothetical example.

FIG. 6 shows a sequence of player actions that illustrates the beginning of a hypothetical puzzle-solving process. The number, 80 shows a random sequence of lettered tiles in the grid for the preferred embodiment. The number, 81 shows two tiles that have been selected by the player, resulting in swapped letter values. The number, 82 shows two more tile pairs being selected by the player, resulting in swapped letter values. The number, 83 shows two more tile pairs being selected by the player, resulting in swapped letter values. The number, 83B shows the word that results from the letter-swapping process. The numbers, 84, 85, and 86 show additional tile selection and letter swaps in a hypothetical puzzle-solving process.

FIG. 7 shows the results of a player clicking on the “check puzzle” link/button, given the hypothetical letter configuration shown in the figure.

FIG. 8 shows the results of a player clicking on the “I give up!” link/button. A possible solution is shown using the lettered tiles. The words comprising the solution are listed below the grid.

FIG. 9 shows a sample welcome web page for the preferred embodiment of the invention and the web-based features available to the player, depending on which feature the player selects. The number, 200 shows the welcome screen with the player options. The number, 201 is intended to identify a cloud-like container, meant to represent the Internet. Inside the container are the major elements comprising the preferred embodiment. The number, 202 points to the welcome interface for the preferred embodiment of the invention. The welcome web page then branches off to either an individual puzzle, puzzle of the day (POD), or POD solution page, depending on the player's selection, as indicated by the number, 203. The number, 204 points to a wordlist that is used by the individual puzzle-generating page. The number, 205 points to a POD file, containing predetermined puzzle of the day definitions, which is used by the puzzle of the day page as well as the POD solution page.

FIG. 10 shows elements that comprise a possible board game embodiment of the invention. The number, 300 shows a tray that holds the lettered tiles that form the word puzzle to be solved. The number, 310 shows a sample tile that would be placed in the tray The actual number of tiles necessary for such a board game embodiment far exceeds those shown here. Sufficient tiles of each letter of the alphabet must be included to solve any puzzle provided in the game cards. A sample game card is shown by the number, 330. A game card contains a solution and suggested letter rearrangement. A plurality of game cards must be included in the game. The number, 340 shows a box containing game cards.

### DETAILED DESCRIPTION OF THE INVENTION

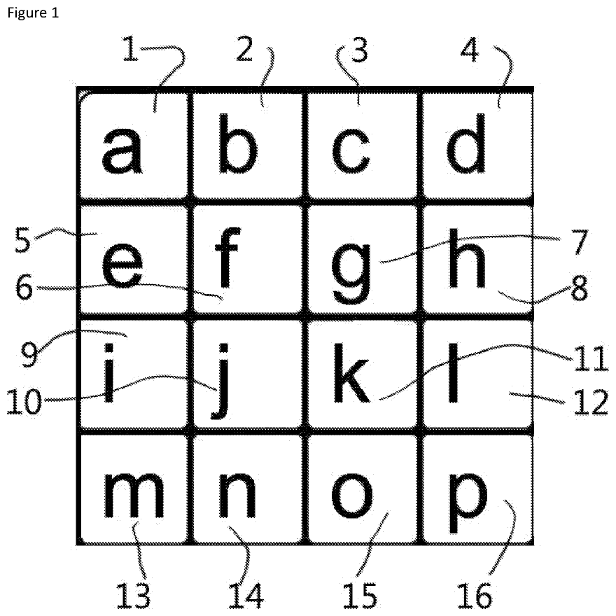

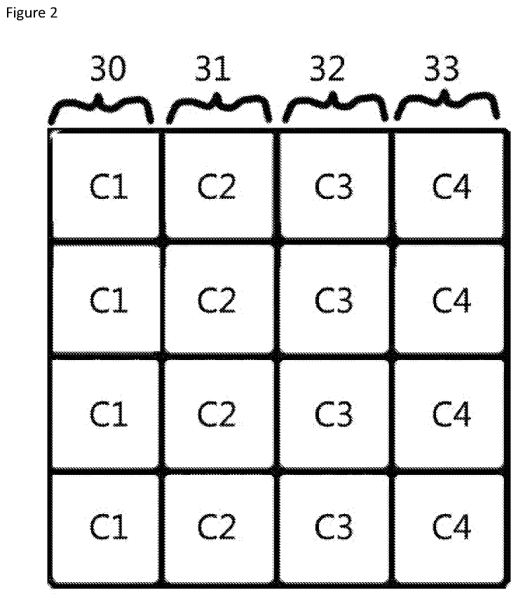

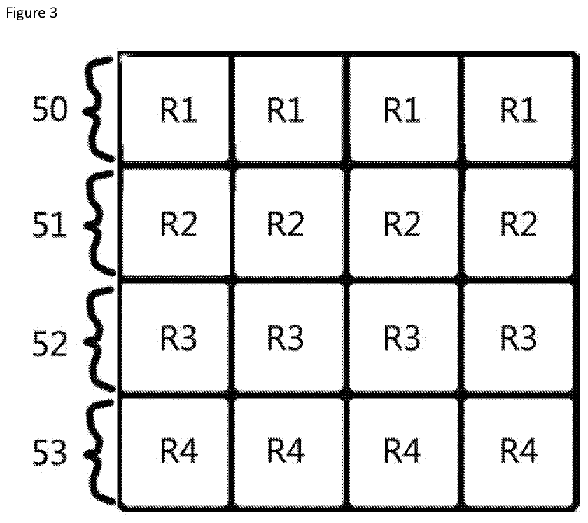

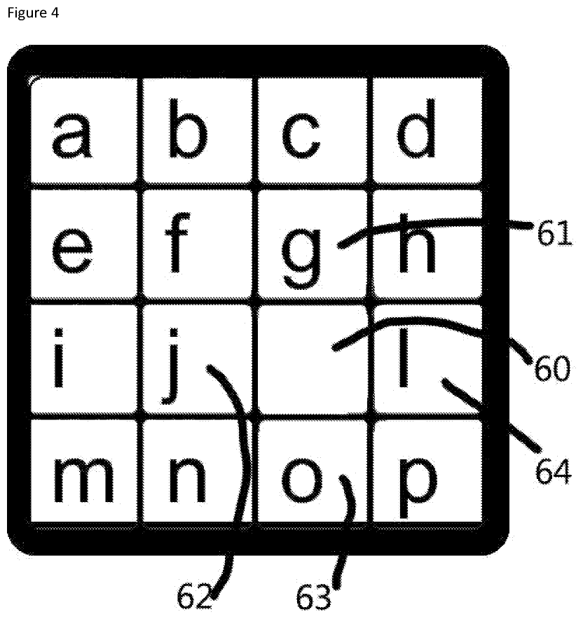

The preferred embodiment of this invention is played on a four-by-four grid of lettered tiles, as shown in FIG. 1. Each lettered tile, shown by the numbers, 1 through 16, represents a game piece and can be manipulated by players. Various embodiments of this invention may vary in how players move game pieces. In the preferred embodiment of this invention, players swap the letters appearing on tiles to reposition the letters and form words to solve the puzzle. Players seek to create a lettered configuration that contains four four-lettered words, reading horizontally from left to right, or reading vertically from top to bottom. FIG. 2 shows how tiles can be aggregated to form vertical words. Four vertically formed words are possible as indicated by the numbers, 30 through 33, respectively. Each column is indicated by the column specification, C1 through C4. Column one consists of all tiles containing the value C1. Column two contains the value C2, and so on. FIG. 3 shows how tiles can be aggregated horizontally to form words. Four horizontally oriented words are indicated by the numbers, 50 through 53. Each row is indicated by the row specification, R1 through R4. Row one consists of all tiles containing the value R1. Row two contains the value R2, and so on. Most puzzles are solvable using a combination of vertical and horizontal words, as will be illustrated subsequently using a specific example.

The preferred embodiment of this invention is computer-based. Other computer-based or mechanical embodiments of this invention may be played in grids of other dimensions, such as a five-by-five or six-by-six. While computer-based embodiments of this invention will have lettered values on all tiles, a physical embodiment of this puzzle, resembling a numeric 15-puzzle, will have one tile missing to allow players to slide tiles into the empty position, as shown in FIG. 4. The number, 60 points to a sample empty space on a hypothetical physical embodiment of the invention. The numbers, 61 through 64 point to neighboring tiles that could be physically moved into the empty space, thereby creating a new empty space in the puzzle.

Computer-based embodiments, including the preferred embodiment, have computer-based methods, or algorithms, that generate puzzles for players to play. The objective of the puzzle creation algorithm is to determine the letters that will reside on the tiles of the grid. This algorithm can be implemented in several ways. The objective of the algorithm is to guarantee that at least one solution exists for each puzzle generated. In the case of the preferred four-by-four embodiment, the puzzle creation algorithm finds a sequence of sixteen letters that will spell four four-lettered words on the grid. These letters are then rearranged before being presented to the player. Any rearrangement of lettered tiles that results in four four-letter words is a correct solution.

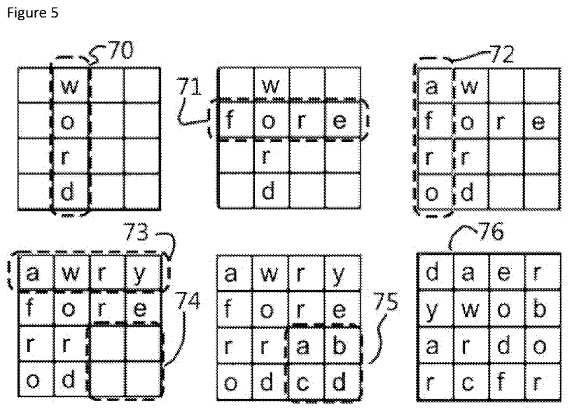

FIG. 5 illustrates a hypothetical word selection process of the puzzle creation algorithm. The algorithm starts by selecting a random word from a wordlist containing words of a suitable length. For the preferred embodiment, the wordlist would contain words containing four letters. A random placement on the grid determines the placement of the selected word, as shown by the number, 70. A random letter is selected from this word to start the selection of a second word, which intersects the first word at the letter's position in the first word. The random word in FIG. 5 is “word”. The letter selected is “o”. A subset of the wordlist is created of four-lettered words that contain an “o” in its second position. A random word from this wordlist subset is then selected. The hypothetical example shows the word, “fore”, is selected and placed on the grid to intersect the first word as shown by the number, 71. The next step in the word selection process is to select a random position on the grid for a third word. In this case, the first vertical position is selected. As a result of this determination, the third word must contain an intersecting letter of the second word. In the hypothetical example, the third word must contain an “f” as its second letter. Another subset of the original wordlist is made such that four-lettered words containing “f” as its second letter is created and then a random word is selected from this new wordlist subset. In the hypothetical example, the word, “afro”, is selected and placed on the grid as shown by the number, 72. If the subset of the wordlist is too small to find a suitable word, a new position on the grid is then selected. After a third word is successfully selected, a fourth word position is located. The intersecting letters are then determined, and a new wordlist subset is made so that the final word will intersect the appropriate letters. In the case of the example, the selected position is the upper-most horizontal position, the fourth word must start with the letters “aw” to intersect “afro” and “word”. A subset of the wordlist containing four-lettered words starting with “aw” is created and a random word from this wordlist is selected, as shown by the number, 73.

In the event intersecting letters do not allow for a word to be selected, either a new word location is selected, or the selection process (puzzle creation algorithm) starts over with a new initial word. Once four words have been successfully chosen, any tiles not containing letters, like those indicated by the number, 74, have random letters assigned to them as shown by the number, 75. In the case of the hypothetical example, the letters, “abcd” are assigned to the remaining tiles, as 75 indicates. The letters, “abcd” are clearly not random letters. The puzzle creation algorithm would, however, select letters at random to fill in the unoccupied tiles. The final step in the puzzle selection algorithm is to randomize the sequence of letters before the puzzle is presented to the player, as shown by the number, 76.

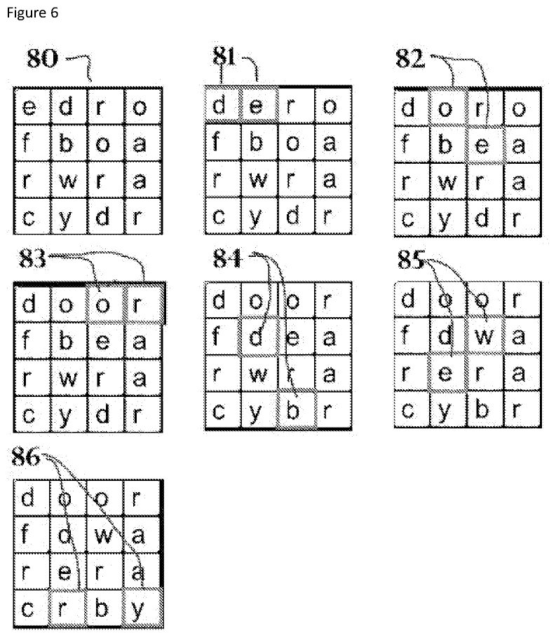

Once the rearranged grid of letters is displayed to the player, as shown by the number, 80, the player begins to rearrange the letters as shown in FIG. 6. Players select pairs of tiles to switch the letter values on each tile. The original lettered tile configuration is shown by the number, 80. Two tiles with the values “e” and “d” are selected by the player which causes them to swap positions in the grid, as shown by the number, 81. Next, the player selects the tiles containing the letters “o” and “e” which causes them to be switched, as shown by the number, 82. The player then selects the letters “o” and “r” to switch places, as shown by the number, 83. This forms the word, “door”, in the uppermost horizontal word position on the grid, as shown by 83B. A series of additional letter switches are shown in the numbers, 84, 85, and 86, respectively. The game is not complete at this point. This set of word choices, shown in FIG. 6, is not guaranteed to lead to a correct solution to the puzzle. A correct solution is any configuration of letters that simultaneously spells four four-lettered words.

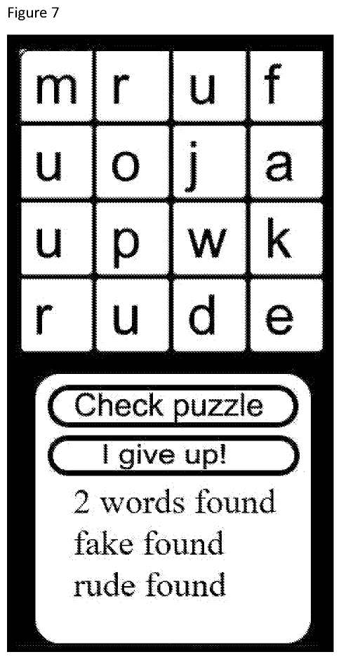

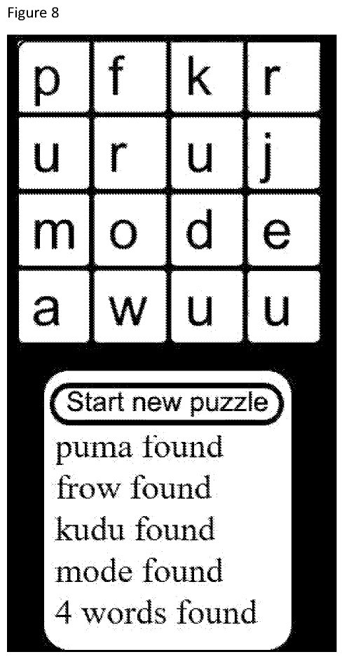

The player may continue to swap letter values until a correct solution to the puzzle is found or may choose to view a solution and thereby cease playing the puzzle. FIG. 7 shows a hypothetical result from the preferred embodiment of the invention in which a player selects the “check puzzle” option. This allows players to determine if any words have been formed or if a solution has been achieved. Should the player wish to see a possible solution to a puzzle, the “I give up” option may be selected, as shown in FIG. 8.

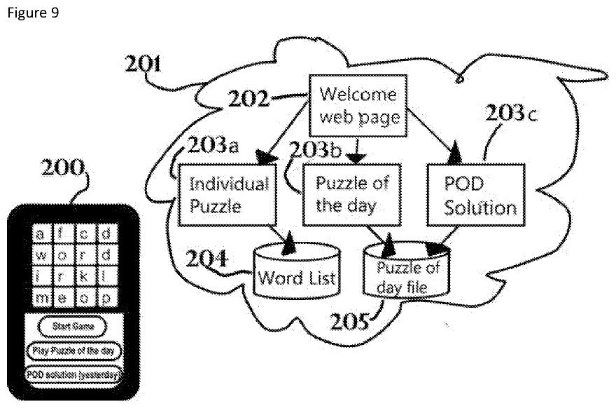

In the preferred embodiment of the invention, there are two categories of puzzles offered to players, an individual puzzle, and a puzzle of the day (POD). The individual puzzle is generated for each player, so each player has a unique puzzle to solve. Each player may play any number of original puzzles. The puzzle of the day is generated once daily for all players to play for a 24-hour period. FIG. 9 illustrates the beginning phase of the preferred embodiment of the invention. The puzzle is accessible by any internet-connected device with a standard web browser, as shown by the number, 200. The internet resources necessary for the preferred embodiment of the puzzle are depicted as being enclosed in a cloud-like container, as shown by the number, 201. The preferred embodiment of the puzzle has an initial web page that allows the player to select which puzzle type is desired, as shown by the number, 202. The options provided by the initial web page are shown by the number, 203. These options are playing an individual puzzle, playing a puzzle of the day (POD), or viewing the solution from the POD from the previous day. The algorithm that generates an individual puzzle requires a wordlist, as shown by the number, 204. The puzzle of the day has its own information resource that defines the puzzle of the day for each day. This information resource is used to display the solution for the previous day's POD.

Varying embodiments of the invention can be created simply by supplying customized wordlists, shown by the number, 204, to the puzzle creation algorithm. For example, a children's version of the puzzle can be created by selecting words for the wordlist that are primarily suitable for children. A culinary version of the game can be created by using a wordlist that contains primarily culinary words. Wordlists can be created from other languages, as well. Of course, if embodiments of the puzzle use grids of dimensions other than four-by-four, the wordlist would reflect this by containing words with suitable numbers of characters. A five-by-five word puzzle would use a wordlist with five-lettered words, for example.

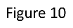

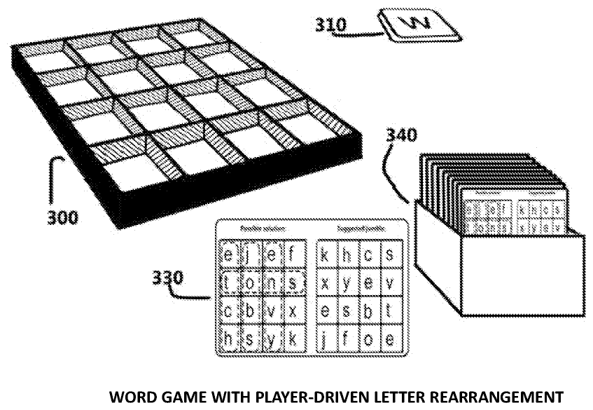

Additional embodiments of the game are possible, including a board game. Elements of a board game are shown in FIG. 10. A board game could be made using the puzzle creation algorithm of the preferred embodiment. The same puzzle-creating algorithm used in the preferred embodiment can generate puzzles that can be printed on cards for the board game. Each card would contain a solution to the puzzle along with a randomized configuration of letters to be presented to the players, as shown by 330. Two or more players can play the game. One person is selected to administer the game by picking a card from a box of cards, shown by 340. Each card contains a solution and a randomized version of the puzzle that is presented to the other players. The person administering the game arranges lettered tiles in a tray, shown by 300, according to the randomized specification on the selected card. The game administrator selects tiles from a tile repository, not shown here, and places the tiles in the tray, according to the suggested jumble. The other players collaborate to solve the puzzle. The administrator determines when the puzzle is solved, keeping in mind that other solutions may exist in addition to the solution printed on the card. A correct solution consists of an arrangement of letters that spells four four-lettered words, in the case of a game using a four-by-four grid. The legitimacy of a word can be determined by the administrator or by a provided wordlist/dictionary (not shown in the figure).

Finally, the board game embodiment needs a point system to determine a winner after a series of puzzle-solving rounds. A sample point system entails awarding the administrator 2 points if the players fail to solve the puzzle in the allocated time (E.g., 3 minutes). The players each receive 1 point if they solve the puzzle in the allocated time. A specific goal can be established, such as ten points, so that whoever reaches that goal first, wins the game. There could be multiple winners under this scenario.

### Rules of Play for the Preferred Embodiment

1) Players should arrange the letters provided in the grid to form at least four four-lettered words.
   All qualifying words must contain four letters.
   Words can be formed horizontally, reading from left to right.
   Words can be formed vertically, reading from top to bottom.
   No other words count. No words formed diagonally, reading from bottom to top, or reading from right to left count.
2) To solve the puzzle a player must rearrange letters, as specified below.
   Click or tap on one letter and then click or tap on a second letter to swap positions of the letters.
3) Check the words you formed through rearrangement by pressing the “Check Puzzle” button.
   The “Check Puzzle” button causes a list of recognized words from the player's puzzle to be returned.
   If the number of words recognized is four or greater, then the player has solved the puzzle.
   If a player feels a word should be recognized and it is not, they are asked to share this word using Twitter, using #playfourword.
4) Rules for word inclusion
   The names of people are not included.
   Names of places are included, but they are all lowercase.
   Words consist of letters only, so no contractions are permitted.
   Words are all lowercase.
   Some words should be capitalized, such as place names, but are included in lowercase.
   No acronyms are included.
   Players are encouraged to submit words that they feel should be included in the game and have been omitted.
5) Play the puzzle as often as you wish or play the Puzzle of the Day (POD) once a day with everyone else. A new POD is available at midnight Eastern Standard Time.

The invention claimed is:

1. A game or puzzle that is solved by player rearrangement of lettered tiles or other manifestations of lettered objects on a square grid of letters where the letters have been selected and initially arranged by a computer-based algorithm or manual method that ensures that a correct solution exists, where the solution consists of an arrangement of letters spelling a number of words where the number of letters per word and the number of words comprising the solution are equal to the dimensions of the square grid of letters.

2. The puzzle selection algorithm or method to the extent it is used to generate games or puzzles specified in claim 1, recognizing that a variety of such algorithms or methods exist for said goal.

3. Any web-based version of the game or puzzle claimed in claim 1 in which players rearrange letters to solve the puzzle on a web-based interface.

4. A boardgame based on the solution of the game or puzzle set forth in claim 1.

5. A physical manifestation of the game that resembles a 15-puzzle comprised of letters that embodies the game or puzzled specified in claim 1.

6. Any three-dimensional manifestation of the game or puzzle claimed in claim 1.

7. Any manually created variation of games or puzzles described in claims 1 through 6 in which players create puzzles for others to solve.

8. Any variation of this game or puzzle claimed in claims 1 through 7 that uses words from different languages or language subsets, such as creating a culinary version of the game or a German version of the game.

9. Any minor variation of the game or puzzle claimed in claims 1 through 8, including, but not limited to, a game or puzzle using a rectangular grid of letters, as opposed to a square grid, or a varying number of correct words comprising the solution.
